(19) United States
(12) Patent Application Publication
(10) Pub. No.: US 2005/0088520 A1
(43) Pub. Date: Apr. 28, 2005

(54) Video camera monitoring of escalators and moving walks

(76) Inventors: Josef Wiesinger, Vienna (AT); Dirk Blondiau, Vienna (AT)

Correspondence Address: Jay A. Bondell, Esq.;SCHWEITZER CORNMAN GROSS & BONDELL LLP, 292 Madison Avenue, New York, NY, 10017, US

(21) Appl. No.: 10/700,266

(22) Filed: Nov. 3, 2003

(30) Foreign Application Priority Data
Nov. 6, 2002 (EP) 02405951.1

(51) Int. Cl. H04N 7/18; H04N 13/00

(52) U.S. Cl. 348/143; 348/42

(57) ABSTRACT

A monitoring system is disclosed for the detection of obstacles and persons on escalators and/or moving walkways having at least one video camera, whereby the monitoring system acquires stereoscopic images. The images are processed in a manner which distinguishes the obstacles and persons from the escalator or walkway. A series of camera pairs may provide monitoring of the full extent of the escalator or walkway.

The present invention relates to video camera monitoring of escalators and/or moving walks according to the definition of the independent claims.

### BACKGROUND OF THE INVENTION

Such monitoring systems are well known in different embodiments as escalator start locks or escalator restart controls. Through such monitoring systems escalator restart after a voluntary or erroneous actuation of emergency stop or other safety device must remain blocked, until no person or object are present in the monitored field of the safety device.

In particular, the escalator restart control conditions are established by European standard E115: an escalator, which is used to transport people in environments such as railway stations, shopping centers etc., should be monitored for security reasons. The monitoring is restricted to the case where an escalator is stopped and a safe restart is required. A safe restart may only be performed in situations where the escalator has been repeatedly tested for emptiness, i.e. that there are no persons or obstacles on the moving parts and the entry regions of the escalator. The required period of emptiness is typically adjusted to 10 seconds. Over this period repeated checks for emptiness may be performed every 0.1 seconds.

Monitoring systems of this type are, for example, described in EP 1013599, JP 10236757 and in JP 10265163. EP 1013599 discloses a monitoring system for escalator restart control, which detects the presence of persons or objects on the escalator through a set of cameras situated above the escalator. Practical experiments have demonstrated that this system does not work in the case of strong sun irradiation, faint diffused light, and in the case of rain, drizzle or fog, and that under these circumstances an unambiguous perception of the emptiness of the escalator cannot be assured.

JP 10236757 shows a remote supervisory system whereby, without dispatching a clerk in charge to a location of an escalator, a moving guide device is remotely supervised, and start and stop control can be performed. This remote supervisory system comprises ITV cameras supervising an escalator and its periphery and a central controller provided in a remote area to control a start/stop of the escalator.

JP 10236757 shows an escalator controller to judge a phenomenon and to speedily respond to, for example, a falling-accident, etc., in accordance with a picked-up picture image of an escalator and its periphery.

Both JP 10236757 and JP 10236757 disclose monitoring systems which do not work properly under certain illumination conditions and cannot guarantee the unequivocal perception of the emptiness of the escalator. In particular, shadows or dirty spots on the escalator can be confused with people or objects lying on the escalator itself.

### BRIEF DESCRIPTIONS OF THE INVENTION

The object of the present invention is to conduct the monitoring of obstacles and persons on escalators and/or moving walks, which allows a reliable and univocal detection of persons or obstacles lying in the monitored field of the escalator and/or moving walk.

According to the present invention this object is achieved by a monitoring system for the detection of obstacles and persons on escalators and/or moving walks comprising at least one video camera for the acquisition of stereoscopic images.

The term “stereoscopic images” is meant to encompass a pair of pictures of the same field of view taken by two cameras situated at slightly different positions, or taken by the same camera placed in two slightly different positions, so that the same field of view is imaged under two slightly different angles. The objects on the escalator which are intended to be detected have the property of being closer to the camera than the escalator on which they are placed. The advantage of stereoscopic images is that these objects appear at different positions in the pair of stereoscopic images. Disturbances like dirt or inscriptions on the escalator appear on the same position in the pair of stereoscopic images, so that it is possible to unequivocally detect the presence of objects and persons on the escalator.

The term “obstacles or persons” is understood to refer to objects and bodies whose dimensions are such as to endanger the safe operation of the escalator and/or moving walk.

In preferred embodiments of the invention pairs of video cameras may be located above the escalator or in the escalator balustrade. Such embodiments exhibit the advantage that an optimal field of view of the escalator can be achieved. Under a view angle of 45° the obstacles and persons are neither too close to the camera (too big in the image) nor too far away (too small in the image). If the escalator is very long, more than one pair of cameras may be necessary to monitor conveniently the entire length of the escalator.

In another preferred embodiment the monitoring system may include a processing unit to process the stereoscopic images. This embodiment exhibits the advantage that the monitoring system can automatically process the acquired images and can autonomously come to a decision as to whether or not obstacles are present on the escalator.

In this context the processing of the stereoscopic images is meant to encompass any operation, preferably performed on digital images, such as loading, storing, comparing, differencing, rectifying, warping, reconstructing, segmenting, grouping, edge detecting, Hough transforming, extracting, etc. and as may be described below in the detailed description of the invention.

The processing unit can be a personal computer or a standardized non-expensive processor integrated in the camera or in any other part of the escalator equipment needing no special device to be mounted.

In another preferred embodiment the processing unit and the cameras can be connected together by linking means or with the escalator controller. This embodiment exhibits the advantage that the monitoring system can automatically process the acquired images, can autonomously come to the decision whether obstacles are present on the escalator or not and can finally automatically restart the escalator based on the obtained information. Linking means are to be understood to encompass any physical means, such as cables, signals or a data exchange bus, which allows data to be exchanged and transmitted between two or more acquisition, processing and controlling units.

According to the present invention the object is also achieved by a method for the detection of obstacles and/or persons on escalators and/or moving walks, whereby at least one video camera acquires stereoscopic images and a processing unit processes these images. The advantage of this method is that it is easy to perform and reliable.

Another preferred embodiment of the invention may incorporate a computer program product for the detection of the obstacles and/or persons on escalators and/or moving walks, which loads in a processor and processes stereoscopic images of the escalator and/or moving walk. The advantage of the computer program product is that it is loadable anywhere, locally or remotely, in a central server and that updates are easy to perform.

### BRIEF DESCRIPTION OF THE DRAWINGS

Preferred embodiments of the invention are described in detail below with reference to the following drawings, wherein:

FIG. 1 is complete representation of the escalator equipped with the monitoring system according to the invention;

FIG. 2 is a perspective view of an escalator incorporating the monitoring system wherein a pair of cameras is placed in the escalator balustrade;

FIG. 3 in a perspective view of an escalator incorporating the monitoring system wherein a pair of cameras is mounted at the top of two posts placed along the escalator;

FIG. 4 is a flow diagram for image data exchange for the monitoring system using a shared memory; and

FIG. 5 is a data flow diagram for the full system.

### DETAILED DESCRIPTION OF THE INVENTION

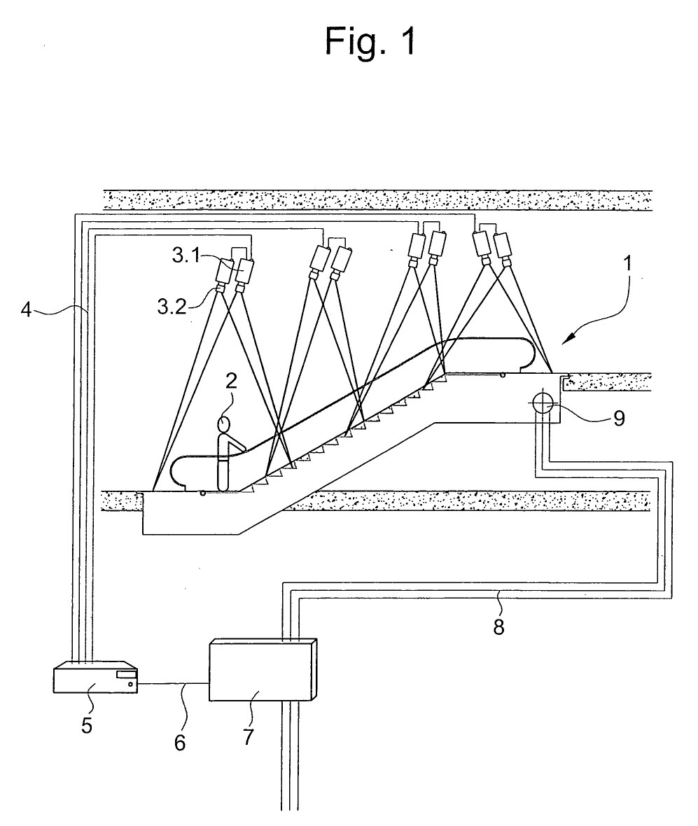

FIG. 1 shows a complete representation of an escalator equipped with the monitoring system according to the invention. On the escalator 1 is standing a person 2, which is in the field of view of a pair of video cameras 3.1 and 3.2 placed at slightly different positions above the escalator. The cameras can therefore acquire pairs of stereoscopic images of the escalator.

Image acquisition is performed using pairs of cameras, where the number nc of cameras required depends on the height of the staircase H. An estimate is given by nc=4+H, where H is the height of the escalator in meters. For example, for a staircase spanning four meters in height four stereo camera pairs, i.e. eight cameras at all, are necessary.

For the internal part of the escalator two cameras with a focal length of 6 mm (nominal) in the turned mode, i.e. the vertical image size is larger than the horizontal one, are suggested. The entry regions at the top and on the bottom of the escalator also require cameras with a focal length of 6 mm (also in the turned mode).

Environment and escalator parameters influencing the placement and the number of the cameras may include, for example, the length of the escalator, which can be up to 100 meters, whether the escalator is located in- or outdoors with or without covering, and whether the escalator stairs are colored or bear inscriptions. An opaque object of cylindrical shape and minimum size of 0.15 meters in diameter and 0.15 meters in height must be detected as a necessary requirement. The illumination may vary over the escalator area, a minimum illumination is given as 50 Lux for indoor placement and 15 Lux for outdoor placement.

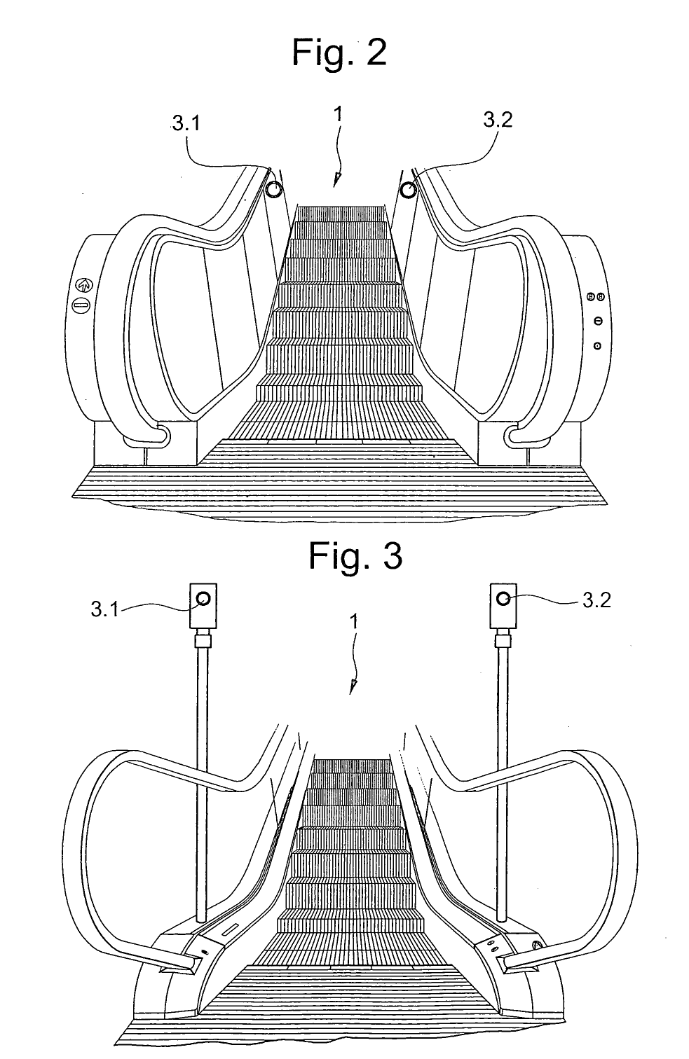

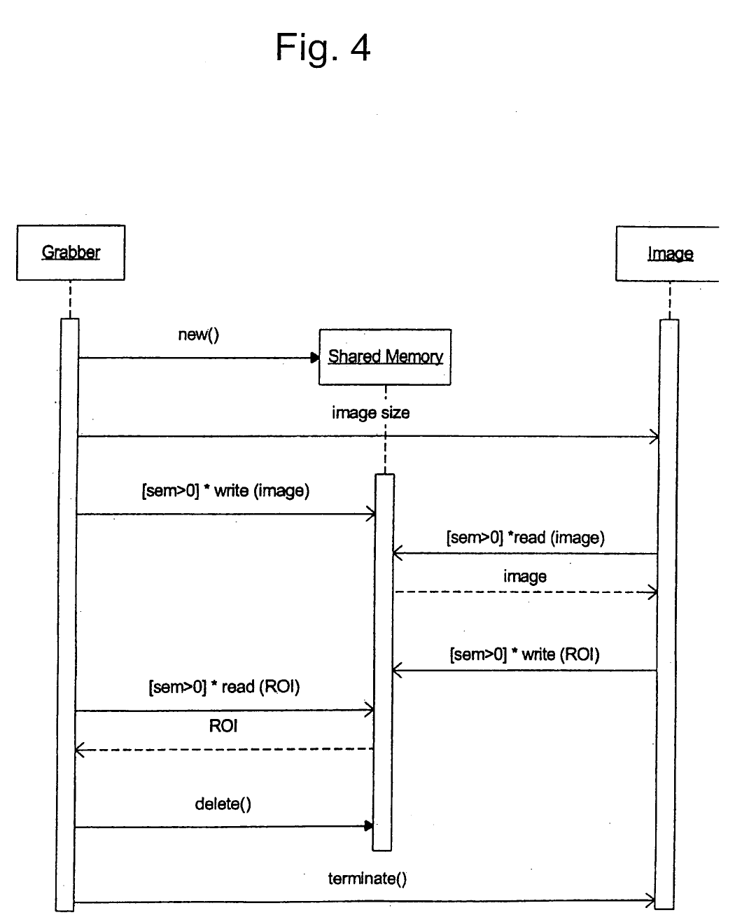

FIG. 2 shows a preferred embodiment of the monitoring system whereby a pair of cameras is placed in the escalator balustrade, while FIG. 3 shows a preferred embodiment of the monitoring system whereby a pair of cameras is mounted at the top of two posts placed along the escalator.

B/W cameras and DFG/BW1 frame grabbers manufactured by The Imaging Source with a progressive scan CCD image sensor can be used. An important additional requirement may be voltage-controllable lenses. This requirement stems from potential highly varying illumination conditions. A preferred lens is a Cosmicar lens, type H612ER, with a focal length f of 6 mm. The aperture opening is controllable from f/1.2 to f/360 through variation of the control voltage in the range 1.5 to 5 volts. The aperture is controlled using a the NuDAQ 6208 multi-channel analogue output card.

The cameras are connected through the linking means 4 (for example Hirose cables) to a processing unit 5, which processes the digitalized stereoscopic images taken by the video camera pair. Thanks to algorithms described below, the processing unit detects the presence or not of a person on the escalator. Detection is based on differencing rectified stereo pair images, where a warping transform overlays the left image onto the right image, and vice versa. The 3D camera positions are obtained through model based pose estimation and disparity is used to obtain the warping transform.

In particular, the task is to detect objects on an escalator, which can be considered as a moving background, under real-world illumination conditions. The suggested solution consists of model based background reconstruction, perspective warping of one image to the other in a stereo setup, and the final detection of differences in an image pyramid. Specifically, a model based staircase pose estimator is employed based on grouping of line features by the use of geometric invariants. Detection is based on measuring absolute pixel differences between unwarped and warped images. Image differences are represented in an image pyramid according to Peter J. Burt, Tsai-Hong Hong, and Azriel Rosenfeld, “Segmentation and Estimation of Image Region Properties Through Cooperative Hierarchical Computation”, IEEE Transactions on Systems, Man and Cybernetics, 11 (12):802-809, December 1981, and segmented into background (staircase) and foreground (obstacles) employing the algorithm suggested in M. Spann and R. Wilson, “A Quad-Tree Approach to Image Segmentation which Combines Statistical and Spatial Information”, Pattern Recognition, 18 (3/4):257-269, 1985.

Image processing is performed on PC-class machines (Intel Pentium). The number of PC boxes can be greater than one. In a preferred embodiment each PC box is responsible for two stereo pairs, i.e. is connected to four cameras. Each PC is equipped with one NuDAQ 6208 and two DFG/BW1 cards.

The software is written in C++ and runs under the Linux operating system. Efficient image, computer vision and matrix algebra algorithms are provided by the Intel Performance Primitives Library.

The main software components are:
Acquisition, including aperture control.
Calibration of camera and system (offline).
Monitoring, state estimation and detection (online). The detection part is the time-critical part performed at escalator service time (online), whereas the calibration part is done beforehand, i.e. at escalator assembly time (offline).

Acquisition performs two tasks:
Providing grabbed images at some negotiated shared memory.

Control of the aperture based on image properties, e.g. maximization of the information content in the staircase region of interest (ROI).

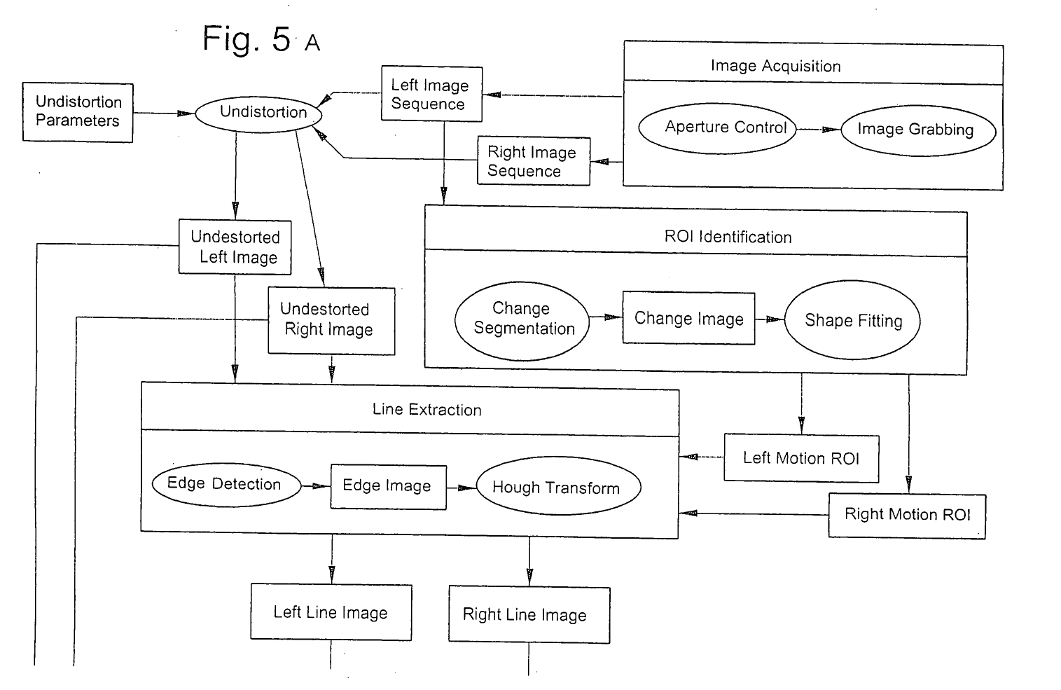

FIG. 4 is a flow diagram, which explains the communication between acquisition components and processes requiring images, i.e. the offline and online components.

The basic principles for synchronization and communication are:
Components are Unix processes.
Image data are exchanged using shared memories.
Synchronization for shared memory access uses semaphores.
Signaling between processes uses message queues.

For the calibration and monitoring part, there are seven main tasks:
Radial/tangential undistortion.
Motion segmentation and ROI identification.
Edge and line extraction.
Geometric matching, model/data line correspondence, pose estimation.
Disparity calculation, warping table setup.
Staircase state estimation.
Image warping, segmentation, connected components labelling, decision support.

The undistortion task is required in the offline and online parts. The next four components can be summarized as the offline component, whereas the last two are the online component.

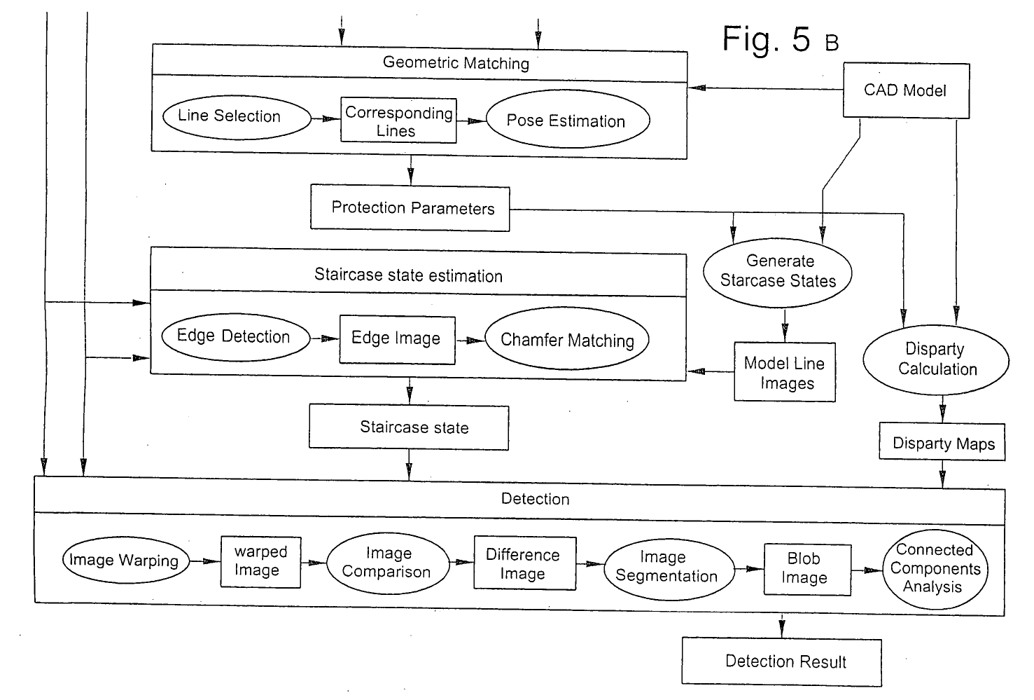

FIG. 5 shows the data flow for the system with the above mentioned components. The external data stores provide undistortion parameters from internal calibration and a CAD model of the staircase, i.e. a list of points and lines. Output, which is the result of detection, goes to another external data store. The main components: acquisition, offline and online, are grouped in shaded areas. Undistortion is applied to images gathered by both the online and the offline component.

As stated above, the main components of the presented system are the acquisition part, the offline (or calibration) part and the online (or detection) part. The most interesting subparts, i.e. geometric matching (establishing correspondences between 2D-data and 3D-model) in the offline part and detection from stereo images in the online part, will be discussed in some detail in the following.

In model-based pose estimation, parameters describing relative orientation and position, i.e. the extrinsic camera parameters, are found using correspondence between data and model. In our case, the data are 2D lines extracted from single images and the model is a 3D wireframe object. Nearly horizontal lines are derived from the image data using standard edge detection based on directional image gradients and Hough transform techniques. To establish correspondence between data and model lines for each image in the stereo pair, and furthermore, between the two stereo pairs, the following matching procedure, (grouping based on cross ratio) is applied.

The first step in matching is to identify possible correspondences between data and model lines. Under perspective projection, ratios of ratios of lines and ratios of ratios of angles, the so-called cross ratios, are invariant. We employ cross ratios to identify groups of four lines out-of a larger set of possible lines. Such a group of 4 lines, which in our case is characterized by the cross ratio obtained for the intersection points with an approximately orthogonal line, serves as a matching candidate to the staircase pattern. The definition for the cross ratio for four points pl, . . . , p4 on a line is given as:
Cr(p1, . . . , p4)=[(x3−x1)(x4−x2)]/[(x3−x2)(x4−x1)],
where x1 . . . x4 are the corresponding positions of each point on the line.

The following strategy for selecting data lines which are good candidates for correspondence to model lines was employed:
Calculate the theoretical cross ratio, e.g. for four equally spaced points on a line this is Crt=4/3.
Detect a reasonable set L (of size N) of close to horizontal lines from the data.
Calculate intersection points of those lines with a close to vertical line.

$$Calculate all M = {( )}_{4}^{N} four \text{-} element subsets of lines li ⋐ L , \\ i = 1 , … , M .$$
Calculate all cross ratios ci corresponding to sets li.
Sort the li with respect to |ci−Crt| (in ascending order).

Only a portion of the sorted groups, corresponding to those of lower distance to Crt, is input to the pose estimation step, which is described below (estimation of position and orientation).

Corresponding groups of lines are input to a procedure similar to RANSAC as described in M. A. Fischler and R. C. Bolles, \hat{ }Random Sample Concensus: A Paradigm for Model Fitting with Applications to Image Analysis and Automated Cartography”, Communications of the ACM, 24 (6):381-395, 1981. Grouping based on cross ratio delivers improved sampling for RANSAC and reduces the number of necessary iterations. The basic idea in RANSAC is that RANSAC uses as small an initial data set as feasible and enlarges the set with consistent data when possible. The required number of random selections ns of samples with a size of s features is given by Fischler and Bolles as:
ns=log(1−pc)/log(1−pi^{s}),
where pc is the probability that at least one sample of s=4 lines is free from outliers. The probability that any selected sample is an inlier is denoted by pi. In our case, due to the improved sampling based on cross ratio, we can safely assume a high pi, e.g. pi=0.8, and choosing pc=0.99, we obtain a number of necessary RANSAC iterations as low as ns=9.

Verification of the pose is based on the procedure devised by David G. Lowe, “Fitting Parameterized 3-D Models to Images”. IEEE Transactions on Pattern Analysis and Machine Intelligence, 13 (5):441-450, May 1991. Lowe approaches the problem of derivation of object pose from a given set of known correspondences between 3D-model lines and 2D image lines by linearization of projection parameters and application of Newton's method. The result of the pose estimation step are two transformations from world to camera coordinate system, i.e. three translational and three rotational parameters for each camera.

The detection from stereo images involves detector calibration, i.e. derivation of disparity and derivation of the two-dimensional warping transform, and the detection itself, i.e. warping of one image to the other, differencing of warped and unwarped images and, finally, segmentation of the difference image in order to obtain a decision.

The warping transform is found from the staircase model and the two world to camera coordinate system and projective transforms obtained by the pose estimation procedure mentioned above. A perspective warping transform provides us with two warping tables which contain the coordinate mapping for both coordinate directions in the image plane. The warping tables are calculated from disparity, which is accurately given due correspondence via the model, in a straightforward fashion.

The main idea in detection of obstacles is to warp one image, e.g. the left image to the right one, and perform some comparison. The objects on the staircase which should be detected have the property of being closer to the camera than the staircase on which they are placed. Therefore, objects in the image being warped appear at different positions than they appear in the unwarped image. On the other hand, disturbances like dirt or inscriptions on the staircase appear in the same position in warped and unwarped images.

To summarize, an extension of stereo based obstacle detection procedures to regularly structured and non-flat background was employed. Grouping based on a cross ratio constraint improved RANSAC sampling. Pose estimation provides externally calibrated cameras, which simplify and accelerate stereo processing and the object detection task which is performed using a pyramid based segmentation procedure. A high reliability of the approach was found experimentally, i.e. a rate of omission of an obstacle in the order of magnitude of 1 percent, and a rate of false detection of an obstacle in the order of magnitude of 5 percent. Cylindrical objects down to a size of less than 15 centimeters in height were detected reliably.

The processing unit is connected through the control line 6 to the escalator controller 7 and can therefore control the restarting of the escalator after a stop in dependence on the detection of a person or obstacle on the escalator.

Signal connections between the PCs and the escalator control use simple wires, through which signals from the staircase control go to each PC and back. Signals from the PC to the control are combined in disjunctive fashion, e.g. an object is detected if any PC signals a detected object, etc.

Three output signals are provided to the control:
Object detected.
Warning, e.g. camera problem.
Failure, i.e. system not working.

Additionally, the system should support a so-called test mode, where images are fed into the system from stored location and not from the cameras. Therefore, two input signals are necessary:
Staircase in standstill.
Test mode requested.

Signaling between monitoring and staircase control is done using the digital input/output channels of the NuDAO 6208 multi-channel analogue output card. Besides the analogue output channels, the NuDAO 6208 card provides four input and four output channels.

The controller is connected through the motor supply line 8 to the escalator motor 9 and can therefore restart the motor or keep it in a still position.

Further technical requirements for the monitoring system are that the system may consist of two independent channels or control units. A watchdog function is required, i.e. the system may be continuously checked for availability. It is obvious to those skilled in the art that the disclosed system and method using pairs of stereoscopic images can be also used to detect persons and objects in an elevator car or in a lobby in front of elevator doors.

1. A monitoring system for the detection of obstacles and persons comprising at least one video camera and at least one escalator and/or moving walk, characterized in that the monitoring system acquires stereoscopic images.

2. The monitoring system according to claim 1, characterized in that the video cameras are located above the escalator and/or moving walk.

3. The monitoring system according to claim 1, characterized in that the video cameras are located in a balustrade of the escalator and/or moving walk.

4. The monitoring system according to claims 1, 2 or 3, characterized in that more than one pair of video cameras are arranged along the escalator and/or moving walk to monitor a full length of the escalator and/or moving walk.

5. Monitoring system according to claims 1, 2 or 3, characterized in that, the monitoring system further comprises a processing unit for processing the stereoscopic images.

6. The monitoring system according to claim 5, characterized in that, the monitoring system further comprises at least one of a means for linking the video cameras with the processing unit, in the form of a data exchange bus, and a means for storing the stereoscopic images.

7. The monitoring system according to claim 5, characterized in that the processing unit comprises at least one personal computer loaded with an image processing software program for comparing digital data of a model image with data of an actual acquired image.

8. The monitoring system according to claim 5, characterized in that, the processing unit is integrated with at least one camera.

9. The monitoring system according to claim 5, characterized in that, the monitoring system is connected electrically to a control for restarting the escalator and/or moving walk after a stop only when no obstacle and/or person is detected on the escalator and/or moving walk.

10. A computer program product for the detection of obstacles and/or persons on escalators and/or moving walks, characterized in that the computer program product loads in a processor and processes stereoscopic images of the escalator and/or moving walk.

11. The computer program product according to claim 10, characterized in that the computer program product includes means to restart the escalator and/or moving walk after a stop only when no obstacle and/or person is detected on the escalator and/or moving walk.

12. A method for the detection of obstacles and persons on escalators and/or moving walks, comprising the steps of acquiring stereoscopic images of an escalator and/or moving walk by at least one video camera and processing the images of a processing unit

13. The method according to claim 11, further comprising the steps of restarting the escalator and/or moving walk automatically after a stop only when no obstacle and/or person is detected on the escalator and/or moving walk.
